(19) United States
(12) Patent Application Publication
(10) Pub. No.: US 2026/0203775 A1
(43) Pub. Date: Jul. 16, 2026

(54) SYSTEM AND METHOD FOR COMPUTERIZED FRAUD DETECTION USING A LARGE LANGUAGE MODEL

(71) Applicant: Actimize Ltd., Ra'anana (IL)

(72) Inventors: Sunny THOLAR, Pune (IN); Ankur PALIWAL, Pune (IN); Amol KOKATE, Pune (IN)

(73) Assignee: Actimize Ltd., Ra'anana (IL)

(21) Appl. No.: 19/019,765

(22) Filed: Jan. 14, 2025

(51) Int. Cl. G06Q 30/018

(52) U.S. Cl. CPC G06Q 30/0185

(57) ABSTRACT

A computerized system and method for fraud detection, including: generating, using a machine learning model, a verbal description of features of an input data item, computing, by an internal layer of the machine learning model, a numerical representation for the generated verbal description, and determining a probability of fraud for the input data item using reference representations. In some embodiments, probabilities of fraud may be used as features in elaborate computerized fraud prediction frameworks—where a second machine learning model (e.g., separate and distinct from the model used for generating verbal descriptions or numerical representations of input data items), may be trained and used for predicting final fraud probabilities based on a wide variety of features.

### FIELD OF THE INVENTION

The present invention relates generally to computerized fraud detection, and more specifically to fraud detection using large language models (LLMs).

### BACKGROUND OF THE INVENTION

Non-LLM-based methods in fraud detection, such as rule-based systems and traditional machine learning models, may struggle with adaptability and scalability. These approaches often rely on predefined rules and historical patterns, making them less effective at catching new or evolving types of fraud that don't fit existing patterns. Additionally, they can have difficulty processing and understanding unstructured data like emails or text messages, limiting their ability to detect fraud tactics that involve nuanced language or subtle contextual clues. As a result, non-LLM methods may miss complex fraud schemes or generate a high number of false positives, requiring more manual review and increasing the risk of missed threats.

Unlike traditional rule-based systems, which rely on predefined patterns and are limited in flexibility, LLMs can adapt to evolving fraud tactics by learning from new data and identifying subtle, previously unseen correlations. Their natural language processing capabilities allow them to understand context, intent, and nuances in communication, making it easier to spot red flags like phishing attempts, impersonation, and other social engineering tactics. As fraud methods continue to grow more sophisticated, there is a growing interest in using machine learning models, and specifically large language models (LLMs), for achieving scalable and adaptive solutions for identifying potential threats.

### SUMMARY

A computerized system and method for fraud and/or anomaly detection may include: generating, using a machine learning model or large language model (LLM), a text narrative or verbal description of features of an input data item (and describing, e.g., feature or attribute values describing or being associated with the input item in tabular data or a database); computing, by an internal layer of the machine learning model or LLM, a numerical representation or vector embedding for the generated verbal description; and determining a probability of fraud or fraud score for the input data item by comparing the generated representation or embedding to reference embeddings.

In some embodiments, probabilities of fraud may be used as features in elaborate computerized fraud prediction frameworks—where a second machine learning model (e.g., separate and distinct from the model or LLM used for generating verbal descriptions or numerical representations of input data items), may be trained and used for predicting final fraud probabilities based on a wide variety of features.

In some embodiments, machine learning models or LLMs may be trained using randomly sampled data items, such as, e.g., data items sampled using a Bernoulli trial. In some embodiments, data items (such as, e.g., training data items) may be labeled based on having features or attribute values in common with items or data transfers known to involve fraud.

For an incoming or newly requested data transfer, some embodiments may perform automated actions such as, e.g., block, delay, or allow the transfer based on the probability of fraud calculated for it.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows an example system for intelligent fraud detection according to some embodiments of the invention;

FIG. 3 shows example artifacts that may be included in an example data collection process according to some embodiments of the invention;

FIG. 4A-B shows which shows an example data processing and model training process according to some embodiments of the invention;

FIG. 5 illustrates example feature engineering and selection processes according to some embodiments of the invention;

FIG. 6 shows an example narrative generation by a large language model according to some embodiments of the invention;

FIG. 7 illustrates an example vector embedding generation process according to some embodiments of the invention;

FIG. 8 illustrates an example process for narrative and embedding generation according to some embodiments of the invention;

FIG. 9 shows an example feature enhancement procedure according to some embodiments of the invention;

FIG. 10 shows an example system for fraud detection using a large language model (LLM) according to some embodiments of the invention;

FIG. 11 shows an example process for alert generation and for performing automated actions according to some embodiments of the invention; and

FIG. 12 shows an example process of computerized fraud detection according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Some embodiments may generate, using a large language model (LLM), a verbal description or text “narrative” describing an input data item or its features—where the input data item may describe a data transfer or computerized transaction. Embodiments may calculate a probability of fraud (e.g., as score such as an anomaly score, which may be a floating point number between 0.0-1.0 where 1.0 may indicate a high probability of fraud, or that a data transfer is similar to fraudulent transfers and is likely to involve fraud, and where 0.0 may indicate a low probability of fraud, or that the data transfer is dissimilar to fraudulent transfers and is less likely to involve fraud) for the data item—for example by calculating the similarity between the numerical representation or embedding of the verbal description generated for the data item and a reference embedding(s) or representation(s) (which may be known to be associated with fraudulent activity, or with anomalies; for example, a cosine similarity formula which may be used for similarity calculations according to some embodiments—see below). In some embodiments, probabilities of fraud, fraud scores, or anomaly scores may be used as features in machine learning based fraud prediction—where, for example, a second machine learning model (e.g., which may be separate and distinct from a first model or LLM used for generating verbal descriptions or text narratives for data items), may be trained and used for predicting final fraud probabilities based on a plurality of features including, e.g., text-narrative-based similarity scores.

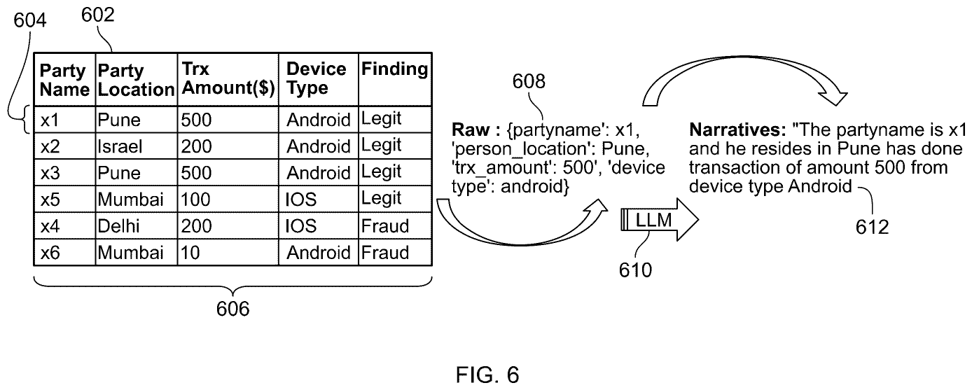

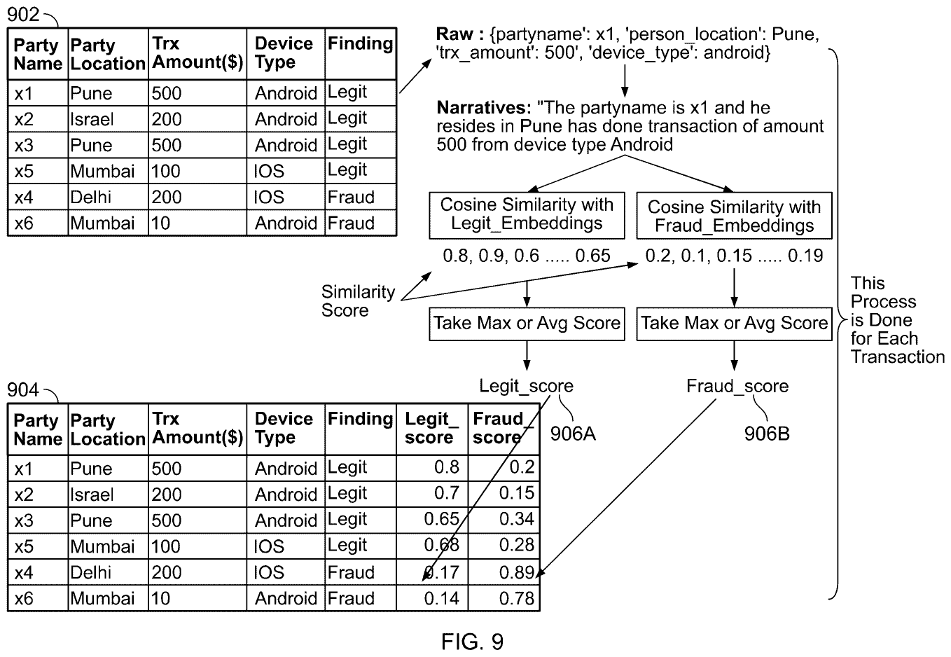

A computerized transaction or data transfer as used herein may refer to or may include sending computerized data items over a data or communication network, or input to a computer (with or without network activity). A transaction or data transfer (both terms may be used interchangeably herein) may include sending or transmitting a computerized data item or items including a computerized request or command, to a server, remote computer system, or cloud platform (as a nonlimiting example, a computerized system operated by a user may send a data item or request to withdraw money from an automated teller machine (ATM); another nonlimiting example may be, e.g., a user operating a computer device may send a computerized request to update a password to a remote server maintaining a database or used credentials or password data). In some embodiments transactions or data transfers may be recorded and/or documented and/or described using a database or databases of historical transactions as, e.g., illustrated in FIGS. 6, 9.

Historic data transfers or transactions may refer to database records describing data transfers which requested and/or performed and/or documented at a point in time earlier than, e.g., an incoming or requested data transfer—which may refer to a database record or entry describing a data transfer which may have not yet been performed, processed, or executed. A nonlimiting example format for database records may be, for example, table rows or entries, generally referred to herein as “tabular data”.

While some embodiments of the invention may be used, for example, for detecting fraud in computerized transactions associated with monetary events (e.g., money transfer, withdrawal, purchases, etc.), other embodiments may be used, for example to analyze data and/or detect fraudulent activities—as well as anomalies/irregularities—in contexts unrelated to monetary events (such as, e.g., analyzing user actions such as password changes or use of credentials to detect fraud).

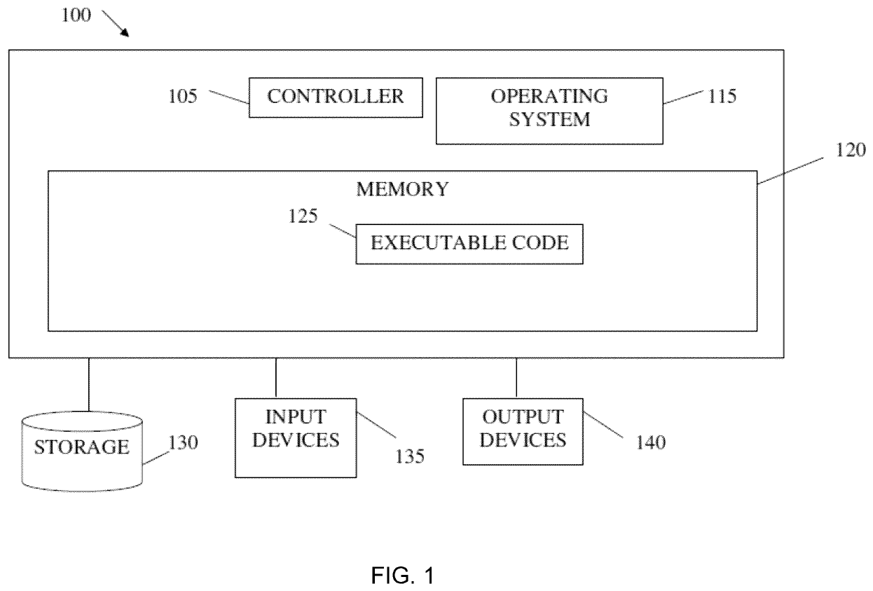

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

Some embodiments of the invention may provide ways to enhance or improve fraud or anomaly detection models. Some previous systems and methods and fraud detection models have several shortcomings and/or may cause several problems:
Financial losses: ineffective or inaccurate fraud detection models may fail to identify and prevent fraudulent activities, which may result in significant financial losses.
Customer dissatisfaction: cases where fraud goes undetected may compromise customer data and finances, leading to customer dissatisfaction and loss of trust.
Vulnerability to evolving threats: fraudsters continuously develop new fraud techniques, and outdated fraud detection models may fail to adapt. With the advent of generative AI, it may be needed to enhance the existing fraud prevention measures.
Reputational damage: high-profile fraud incidents may severely damage an organization's or institution's reputation, eroding users or customer trust and potentially leading to long-term consequences for the organization.
   By addressing these problems and improving fraud detection models, some embodiments may improve fraud detections while maintaining compliance with various regulatory requirements.

With a novel use of LLMs, some embodiments may enhance or improve fraud and anomaly detection techniques and capabilities of existing models. Some embodiments may include assigning a “legitimate similarity” score and/or a “fraud similarity” score to each transaction, which may then be used as probabilities of fraud and/or used with additional indicators, features, or attributes by machine learning models and techniques to improve overall fraud detection performance. Embodiments may improve ML and NN technology by using data from an internal layer of an ML model, instead or in addition to merely using the output. By using LLM based enhanced features for fraud detection (such as for example features calculated using a similarity or distance between a vector embedding representing attributes or features for an incoming transaction, and a reference embedding describing or associated with transactions known or labeled as fraudulent), some embodiments may perform better than previous approaches and technologies for fraud/anomaly detection, e.g., in terms of detection rates or true positives. Enhanced LLM based features such as, e.g., described herein may be highly indicative and statistically correlated with fraud compared to other, non LLM-based features.

Some embodiments may integrate machine learning models such as, e.g., large language models (LLMs) into fraud or anomaly detection processes to provide the following example features and/or improvements:
Leveraging natural language understanding: traditional machine learning models for fraud detection may rely heavily on structured data and predefined features. However, fraud may manifests itself in unstructured data, such as transaction descriptions, merchant details, and other contextual information, which may for example be provided in natural language and/or in an unstructured text format. LLMs may be used for understanding natural language items or inputs, enabling to extract valuable insights from unstructured data sources. For example, by converting transaction data into text narratives, LLMs may be used to analyze nuances and subtleties present in the textual descriptions, potentially uncovering patterns and anomalies that traditional models, requiring structured inputs, might miss.
Capturing contextual information: fraud detection may require understanding the broader context surrounding or associated with a transaction. LLMs may be used to capture and analyze contextual information present in transaction narratives or textual descriptions, which may include, e.g., the merchant's reputation, location details, and unusual patterns or deviations from typical behavior. Contextual understanding may provide valuable clues for identifying potential fraud scenarios that might be difficult to detect using structured data alone.
Integration with traditional models: by incorporating fraud and/or legitimacy similarity scores as additional features or training features for machine learning models, some embodiments may benefit the strengths of both traditional machine learning techniques and LLM approaches and tools. For example, an LLM may be used for natural language understanding and contextual analysis capabilities, while traditional models may be used for pattern recognition and decision-making abilities and features. A hybrid approach including or involving both LLMs and traditional machine learning models may lead to a more robust and effective fraud detection system, capable of handling both structured and unstructured data.

Some embodiments may use LLMs, for example, to generate fraud and legitimacy scores based on analyses of text narratives or verbal descriptions of data transfers or computerized transactions (which may themselves be generated using an LLM), and scores may then be incorporated as features, e.g., into additional components such as for example traditional machine learning models. Some embodiments may accordingly provide a novel solution combining, e.g., natural language understanding, contextual analysis, continuous learning, and interpretability, to mitigate limitations of existing approaches and techniques. Some embodiments of the invention may improve fraud detection technologies, e.g., by detecting fraudulent events and/or data transfers that might otherwise not be detected.

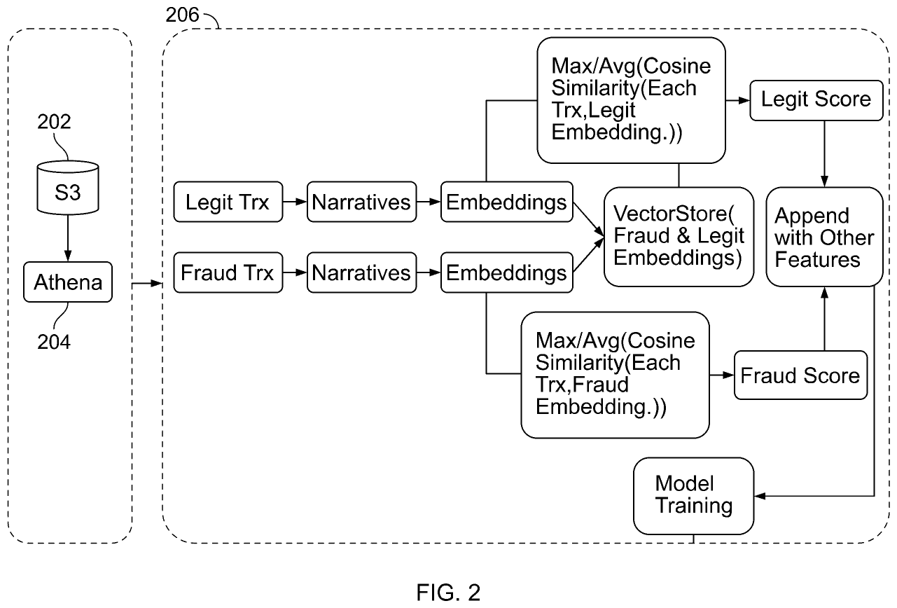

FIG. 2 shows an example system for intelligent fraud detection according to some embodiments of the invention.

Data Collection from Amazon S3 202: data (such as for example data items describing data transfers or computerized transactions, which may analyzed and/or be used as training data in some embodiments of the invention) that may be used of or may be essential for analysis may originate or may be extracted from an Amazon S3 component, a secure and scalable object storage service. A wealth of customer information may be housed, encompassing a diverse range of data types. This may include static customer data, such as demographic details and contact information; historical behavioral profiles, which capture past interactions and preferences; recent transaction data, and the like—providing insights into past or current activity patterns. This data may be sent, for example, to a dedicated server and be stored in a database or in cloud storage components such as, e.g., the S3 and/or Athena 204 component by Amazon Web Services (AWS or AW). Additional or alternative storage and/or cloud components may be used in different embodiments.

Some embodiments may include an LLM based fraud score calculation component or module 206, that may be used for generating verbal descriptions or text narratives for data items, and/or calculating numerical representations (such as for example vector embeddings) for verbal descriptions or text narratives, and/or calculating similarity scores or probabilities of fraud for data items—for example by comparing an embedding for a verbal description of a data item with a reference embedding (e.g. a vector representation, or numerical representation) describing, e.g., historical data transfers, computerized transactions, or events labeled as or associated with/known to involve fraud. Calculated scores may be used, e.g., in the training of a machine learning model (which may be, e.g., separate and distinct from the model or LLM used for generating verbal descriptions or text narratives and/or embeddings of data items) which may predict final fraud scores or probabilities of fraud based on a plurality of features or data attributes.

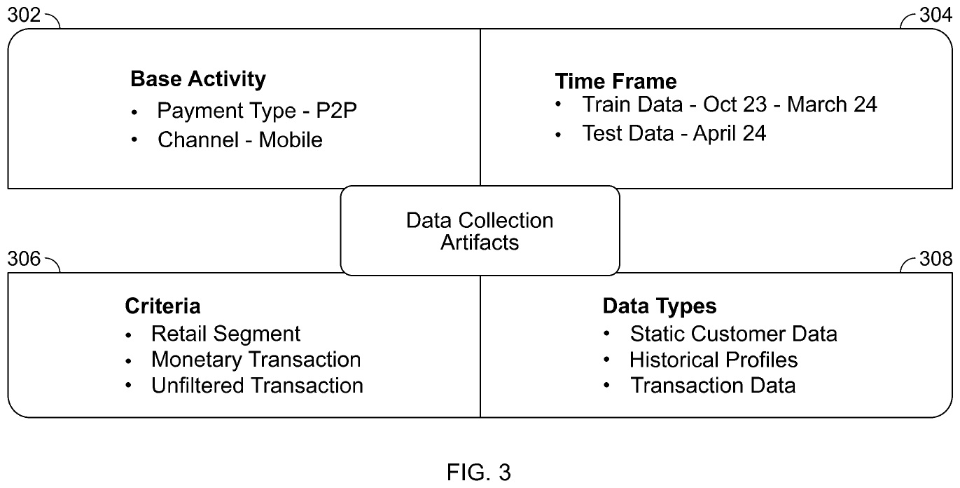

Reference is made to FIG. 3, which shows example artifacts that may be included in an example data collection process according to some embodiments of the invention.

Some embodiments may collect and/or classify data (such as for example database records or tabular data describing transactions or data transfers) according to a plurality of features, attributes, fields, variables or parameters. Example features or attributes may include, for example, a base activity 302 (e.g., a payment/transaction type and/or a channel used in a transaction, such as for example credit card/mobile phone app, and the like; this may be a label of a type or category of activity), a time frame or time period 304 (e.g., between October-November 2024), additional parameters or criteria 306 (e.g., a retail segment or sector associated with the transaction or activity, whether the transaction or activity relates to a monetary transaction or monetary exchange, and the like), and a data type(s) 308 (e.g., static, unchanged or fixed customer data or information such as age, address, and the like, data describing historical profiles of users, newly executed or pending transactions, and the like).

In some embodiments a machine learning model (such as for example the LLM and/or a second machine learning model, which may be separate and distinct from a first model or LLM used for generating LLM based features or fraud probabilities) may be trained using one or more training data items, wherein the training data items are received within a predetermined time period, and wherein each of training data items is sampled based on a Bernoulli trial.

Data sampling: some embodiments may sample data—such as database records, tabular data entries, and the like—describing or associated with a predefined or predetermined time period or time window (such as, e.g., historical data generated or produced up to 6 months prior to the current date). To reduce the amount of sampled data (for example, the number of transactions or activities associated with or described as P2P and/or retail may reach millions of transaction per day) and to handle large training datasets, some embodiments may sample transaction or input data using, e.g., a Bernouli sampling method or procedure.

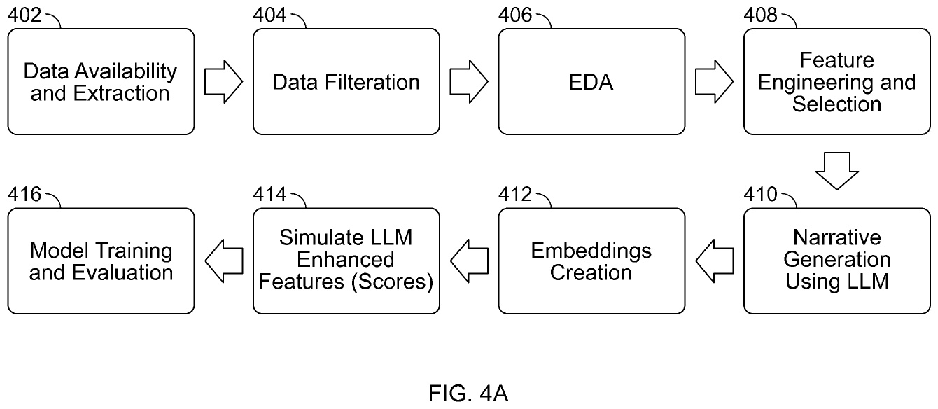

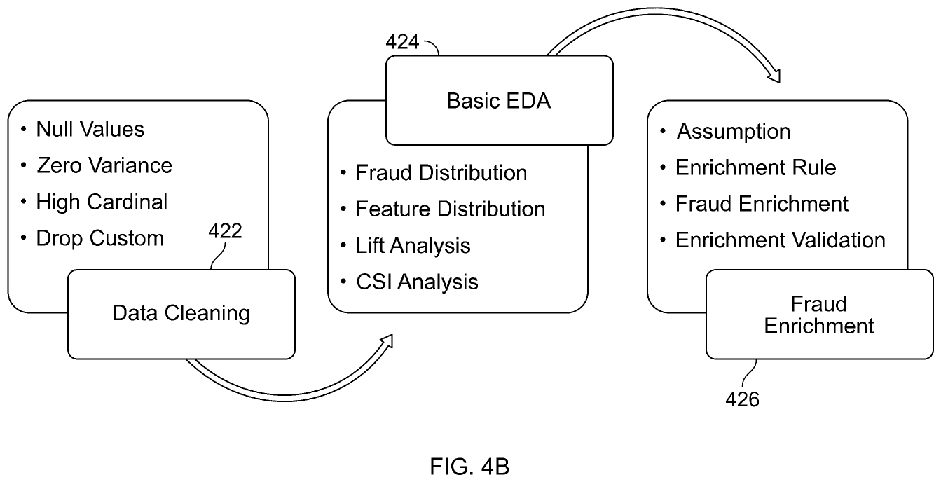

Bernoulli sampling according to some embodiments may refer to a probabilistic sampling process, e.g., of training data items or elements, where each element of a population or data source may be subjected to an independent, Bernoulli trial which determines whether the element becomes part of the sampled training dataset, or the set of elements sampled or selected from the population. In such a sampling process, every member of the population have the same probability of being sampled or selected for model training. An example formula for Bernoulli sampling according to some embodiments of the invention may be, e.g.:

$$f ( k ; p ) = p ( k ) + ( 1 - p ) ( 1 - k ) \qquad ( eq . 1 )$$

Where p is a probability for an outcome of a variable k (such as, e.g., if k is binary variable having possible values of 0 or 1, or being sampled/not sampled, p may be the probability of k=1, or of sampling a data item), and where f is the probability mass function of k, which may provide the probability of observing k in a single Bernoulli trial. Different values or parameters (such as for example a value of p in eq. 1), and/or different formulas may be selected (for example, pre-selected by a system administrator) and used in different embodiments of the invention. Reference is made to FIGS. 4A-B, which shows an example data processing and model training process according to some embodiments of the invention.

Customer data availability and extraction 402 may include, for example:
Identify tenants: some embodiments may identify different tenants or users from, or corresponding to, a given base activity. The first step may be to identify all tenants (e.g., users or accounts, with corresponding user/account identifiers and/or additional details) documented in the system, for which data describing a given base activity may be extracted.
Data availability/data extraction, for example from an integrated fraud management (IFM) database: to conduct analysis, data (such as, e.g., database records or tabular data, as illustrated in FIG. 6, 9) may be extracted from an IFM database, spanning a predefine timeframe (of, e.g., 3 to 6 months). This extraction may be based on a common feature or characteristic, or on common labels known as “base activities”. Base activities according to some embodiments may be groupings or categorizations of events within client systems, or of data items describing such events/data transfers/transactions that may serve as a logical framework for profiling and detection purposes. For instance, a base activity may be, e.g., “Mobile P2P Retail”, or “credit card contactless payment”. Additional or alternative event types may be used in different embodiments.
Data collection from S3: data items or elements that may be used for analysis may be sourced or extracted from S3, where information from various clients, users, or customers may be stored. This data may undergo filtering processes to extract relevant information, for example based on specific conditions or criteria.
Recent data utilization: some embodiments may prioritize the use of more recent data generated or shared by users or customers. For example, recent historical data transfer or transaction data (such as for example data generated or collected within a predefined or predetermined time period of 3 months prior to the current date) may be augmented or enriched with transaction attributes or features—which may, e.g., computed using a fraud detection software or platform such as for example the Actimize Watch platform for financial crime prevention—to create a comprehensive and informative dataset for model development and analysis. Additional or alternative components may be used for feature calculation or augmentations according to different embodiments. The resulting dataset may be used as a training dataset for machine learning models or LLMs for fraud detections and may serve as the foundation for developing advanced analytics, for example within the Actimize platform or a different platform, software or framework.

Data filtration 404 may include, for example:
Data cleaning for ensuring data quality: quality of input data and the accuracy of data processing may be paramount for building high-quality models. To achieve this, data cleaning procedures may be employed to eliminate any unreliable or inconsistent data. Additionally, certain input data items or points may require transformation into numerical values to facilitate their incorporation into models and/or equations.
Exclusion of filtered transactions or data items/points: data items (corresponding to or describing, e.g., data transfers or computerized transactions) that have undergone filtering processes and were deemed unnecessary for model development may be excluded from consideration. Filters, in this context, may represent or refer to technical/logical rules that may be applied to input data (e.g., to evaluate incoming transaction data). The purpose of these filter rules may be to streamline transaction processing by determining whether a transaction requires further assessment, or whether it should be used in training a machine learning model (or, e.g., whether it represents a data point which may introduce errors or statistical biases, and which should therefore not be used in training a model). The process may involve gathering data from various sources, extracting relevant information based on predefined criteria, including a comprehensive set of features for model development, and applying filtering rules to streamline transaction processing before model evaluation. This approach may ensure that the machine learning model is trained on a robust dataset, optimizing its effectiveness in fraud detection and prevention.
Quality control and data validation: to maintain the integrity of the model development process, quality control (QC) or data validation procedures or checks may be performed on, or may be applied to the dataset, or to sampled data items or data sampled for training. These checks may aim to identify any anomalies or issues that could potentially compromise the quality or performance of the model, if trained using the sampled data. Any issues detected during the data gathering phase may be addressed promptly to ensure the robustness and reliability of the model. Utilization of recent data combined with attributes (such as for example calculated using the Actimize Watch suite, or a different component) may allow for the creation of more advanced models. Ensuring data quality through cleaning procedures and validation checks may be essential for developing accurate and reliable fraud detection models (which may be utilized or used as part of fraud detection programs or platforms such as, e.g., the Actimize Watch platform).

Exploratory Data Analysis (EDA) 406: reference is made to FIG. 4B, which shows an example exploratory data analysis process according to some embodiments of the invention.

Some embodiments may perform an EDA process or procedure, which may include, several steps or operations such as, e.g., data cleaning, basic EDA, and fraud enrichment operations, each including various subprocesses or suboperations.

Data cleaning 422 may include:
Null values: this operation may involves identifying and handling missing feature/attribute values (such as for example values that may be missing in some columns of a database entry such as illustrated in FIGS. 6, 9), fields, or information within the dataset. Missing values may adversely affect model performance, so techniques such as, e.g., imputation (filling missing values with estimated ones) or deletion (removing rows or columns with missing values) may be applied.
Zero variance: features or attributes (which may be represented as columns in a database or tabular data as, e.g., a “Trx Amount($)” feature illustrated in FIG. 6) having zero variance, or that have constant values across all samples in the dataset, may be identified and removed from the dataset. These features may not contribute any meaningful information to the model and may be safely dropped.
High cardinality: features with having more categories or many different values across the dataset (such as, e.g., more than a threshold of 50 different values) may be identified and removed from the dataset. High-cardinality features may create a large number of dummy variables and reduce model performance.
Drop custom features/avoid using tenant or region specific features: features or attributes sthat may be specific to certain tenants or regions and do not generalize well across the dataset may be dropped. This may ensure that the model remains robust and applicable to diverse cases and scenarios.

Basic EDA 424 may include:
Fraud distribution: some embodiments may check a fraud distribution, or data points included in the dataset that are known to be associated or to describe fraudulent activities or anomalies, across the given time period to ensure a sufficient amount of information describing fraud is available for model training.
Feature distribution: after data cleaning, some embodiments may analyze the feature distribution for each variable or field in the dataset, for example using the following conditions: For a numerical feature, or for a feature including numerical values, calculate parameters for feature values such as, e.g., minimum value, maximum value, mean/average value, standard deviation (SD), distinct value count, and the like, based on all values existing in the dataset. For a categorical or binary feature or attribute (having, e.g., only 0 and 1 as possible values), some embodiments may calculate a fraud percentage or rate and non-fraud/legitimate percentage or rate for each binary value of the categorical feature in the dataset (such as, e.g., 50% of the data points having feature V=0 are associated with fraud; 33% of the data points having feature V=1 are associated with fraud).
Lift Analysis: a lift analysis according to some embodiments may refer to a technique for measuring the effectiveness of each individual variable on a target variable (e.g., whether a transaction or activity involves fraud). Some embodiments may perform separate lift analyses, e.g., one for categorical features and another for numerical features (which may include, e.g., binning or grouping together different numerical features, or different values for these features).
Characteristic stability index (CSI) analysis: a CSI analysis may measure the degree of change in the distribution of features or attributes between two datasets. This analysis may help assess or quantify feature stability or consistency, for example across different time periods. If a feature is not stable enough, or have markedly different values or distributions of values across two datasets, some embodiment may drop or discard such features. Otherwise, embodiments may include the relevant features (such as similarity scores calculated for embeddings or numerical representations of data items based on or using reference embeddings or numerical representations) in analysis and may use the features, e.g., for training of a machine learning model.

Fraud enrichment 426: fraud enrichment according to some embodiments may refer to a process of augmenting data with additional fraud labels obtained from existing information, e.g., associated with or related to fraudulent transactions or anomalies, or to transactions or activities known to be fraudulent. In some nonlimiting examples, this may be achieved, e.g., by rectifying mislabeled transactions that were erroneously tagged as legitimate (“legit”) instead of as fraudulent, for example by bank analysts. Having more data and/or information on fraudulent activities may enhance or improve the accuracy of risk calculations or predictions by a corresponding machine learning model. Some embodiments may perform a fraud enrichment validation process or procedure to validate results of fraud enrichment, and to ensure that the resulting dataset may be balanced and may not include too many samples labeled as fraud or as describing fraudulent activity, for example to avoid noise or statistical biases which may impact model performance.

In some embodiments, one or more of the training data items are labeled based on one or more of: a time difference between a given training data item and a fraudulent data item, and a feature common to the given data item and to the fraudulent data item.

In some embodiments, fraud enrichment and/or labeling training data items or transactions as legitimate or as potentially fraudulent may be carried out based on, e.g., an analysis of data items or transactions closely associated with fraudulent ones (which may be manifested in the transactions sharing features or having features or attributes in common with the transactions or data items known to involve fraud). This process may include or may be based on logical rules, conditions, and criteria—such as for example, labeling transactions involving a user or payee entity for which a fraudulent activity was detected or recorded as “fraudulent” or as “potentially involving fraud” or “potentially fraudulent”. An example fraud enrichment assumption and rule that may be applied to transaction or activity data may be, e.g.:
Legitimate transactions (or non-fraudulent transactions) occurring within a time difference such as, e.g., a day before or after a fraudulent transaction from the same device key may be labeled as “enriched fraud”, or as “potentially fraudulent”/“fraud”. A time period common to a legitimate transaction and a fraudulent transaction may be used in a similar manner (e.g., if both transactions occurred within the same hour, on the same day, then the legitimate transaction may be labeled as “fraudulent”).
Legitimate transactions involving the same payee entity as a fraudulent transaction, or a paying entity common to a transaction known or labeled as fraudulent, may be labeled as “enriched fraud”/“potentially fraudulent”/“fraud”. (In this case, the payee's identifier may be used as an attribute or feature common to the legitimate and fraudulent transactions.)
Legitimate transactions linked to or associated with the same party/device key or identifier as fraudulent transactions (or as a transaction known or labeled as fraudulent) involving the same key (in other words, legitimate transactions associated having a device identifier in common with fraudulent transactions) may be labeled as “enriched fraud”/“potentially fraudulent”/“fraud”.
   Additional or alternative features or attributes common to the given data item and to the fraudulent data item may be used for data labeling, or for labeling of training data items, such as for example various time based features, ratio features, and the like.

In some embodiments, EDA may be followed by additional operations such as, e.g., feature engineering and selection 408, verbal description or narrative generation 410, embedding creation 412, calculation or simulation of LLM-enhanced features or scores 414, and model training 416 (which may be performed, e.g., using the generated scores or LLM enhanced features). Some nonlimiting examples for these steps are described, e.g., with regard to different figures herein.

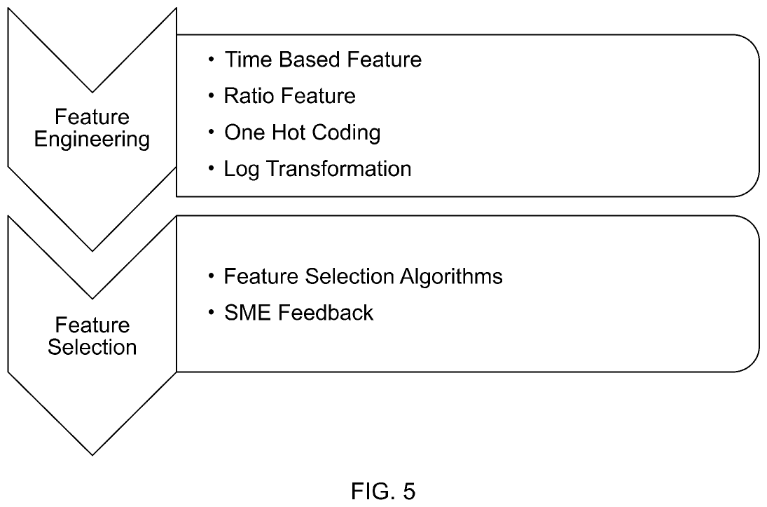

FIG. 5 illustrates example feature engineering and selection processes according to some embodiments of the invention.

Feature engineering and/or features using in data labeling and fraud enrichment according to some embodiments may include, e.g.:
Time based features, which may for example include a “Date/Duration” features (e.g., the date/time on which a transaction took place, as may be described, e.g., using timestamps in transaction data). Additional variables or time based features may include, e.g., “Weekdays/Weekend” (calculate the date column is fall on weekdays or weekend), and “Time Bucket” (which may be derived the time bucket for transaction, for example whether the transaction is happing or taking place in morning, afternoon, evening, night, and the like). In some example time based features, one date column may be used as a reference to which a given transaction date may be compared (and features or attributes may be calculated, e.g., as a difference between two dates, and/or values, points, or columns representing different dates in a table or database such as, e.g., illustrated in the figures herein).
Ratio features, which may be, e.g., calculated ratios between a plurality features or values. Such features may sometime significant insight to individual features (for example: a ratio for “amount” and “balance” features may be informative in addition to each of these features when considered in isolation).
One hot encoding may be used to create new (binary) columns, indicating the presence of each possible value from the original categorical data.
Log transformation: in this transformation technique each variable may be replaced with its logarithm which may be helpful to make feature distribution more symmetric and to reduce skewness and noise.

A feature selection algorithm according to some embodiments may include, for example:
XGBoost: The feature-importance-from-baseline XGBoost model may be used to provide a significant list of features, or a list of the most statistically significant features in a dataset.
The Boruta algorithm may allow creating a ranking for features, from the most to the least impactful or statistically significant or informative.
The Min-Redundancy Max-Relevance (MrMr) algorithm may rank features based on their importance in predicting a target variable, where “importance” may be quantified or calculated according to or based on relevance and redundancy components.
In addition, features may be selected based on stability (e.g., consistency across different datasets) and lift values or calculations indicating that a given feature or variable is significant or has a causal relationship with another variable.
Subject matter expert (SME) feedback: A final list of the features may be reviewed by an SME and based on their feedback the final list of features may adjusted, features may be added/omitted, and the like.

FIG. 6 shows an example narrative generation by a large language model according to some embodiments of the invention.

Some embodiments may include generating, using a machine learning model, a verbal description of one or more features of an input data item. In some embodiments, the input data item comprises tabular data, the tabular data converted into a large language model (LLM) prompt format. Nonlimiting example LLMs that may be used in some embodiments of the invention include: transformer-based, decoder only models such as, e.g., the Claude 3.5 Sonnet (having up to a 200,000 tokens/context window), Claude 3 Haiku, and Claude 3 Opus models by Anthropic the GPT 4.0o (Context Window: 32,000 and 8,000 token variants), and GPT 3.5-Turbo (~175 billion parameters) models by OpenAI LLaMA 2 (7 billion parameters), and LLaMA 2 (13B parameters) models by Meta, multimodal transformer based models such as, e.g., Gemini 1, and Gemini 1.5 models by Google DeepMind, dense transformer models such as .e.h., Mistral 7B, and the like. As part of narrative or verbal description generation, some embodiments of the invention may, for example:
Develop a set of rules that may define the structure and content of the narratives, and that may require the narrative or description to be coherent and human-readable, avoiding repetitive or robotic-sounding text, and the like. In some embodiments of the invention, rules may be included or may be part of an LLM prompt, e.g., as a set of instructions. Nonlimiting example rules or instructions include, e.g., “generate a narrative based on the following transaction/tabular data . . . the narrative should include transaction information as well as the customer information” and/or “ . . . the narrative generated should only have factual information based on the given data and no assumptions”, and the like. See additional nonlimiting examples herein. In some embodiments of the invention, each transaction may be provided as a JSON file and/or a tabular data format for generating narrative by an LLM, where the data (e.g., JSON file) may be a part of the prompt input into the LLM. A nonlimiting example prompt may include, for example: 1. a “role” LLM should assume (e.g., “as a financial analyst . . . generate a narrative . . . ”, or “as a reporter . . . generate a narrative . . . ”); 2.instructions (e.g., “ . . . include all transaction information and/or values as provided in the JSON file in the generated narrative . . . ”; “ . . . add a 1-paragraph verbal description of the transaction type . . . ”; and/or additional instructions or requirements for generating the narrative); 3. data (e.g., a JSON file or a link to such a file or an alternative data source); an example narratives (optional; e.g., a narrative that was already generated or written by a human analyst which can be used, e.g., as an example for formatting outputs by the LLM). Additional or alternative prompt contents may be used in different embodiments.
The narrative may include a plurality of features and/or selected feature or attribute values for relevant data items. According to some embodiments, a generated narrative may be a verbal description of features describing the input data item. For example, in some embodiments, an input data item or element describing a data transfer or computerized transaction may be or may include tabular data in an example database 602—or, e.g., and example database/table entry 604. Input data item or entry 604 may include a plurality of field, attribute or feature values 606 as, e.g., values in separate fields or columns within the database or table (such as, e.g., a partyName=x1, Party_Location=Pune, Transaction_Amount=$500, Device_Type=Android, and finding/label=legit). Feature or attribute values for a given data item may be input 608 (e.g., in raw or unformatted form and as part of an LLM prompt) into LLM 610—which may, in turn, produce or output a verbal description or text narrative 612 of the input data item. A nonlimiting example verbal description or text narrative describing the aforementioned feature or attribute values may be, e.g., “the party performing the transaction is x1, and it is located in Pune. The transaction is of $500, performed using an Android device type”. Additional or alternative example narratives or verbal descriptions of data items may be generated and/or used in different embodiments.
Some embodiments may generate text narratives or verbal descriptions for a plurality of data items, such as for example for comprehensive datasets of transaction or data transfer data. For example, for each transaction or database entry describing a transaction or data transfer (such as for example represented by the plurality of rows in the table or database 602), some embodiments may iterate through the relevant columns and may populate a narrative (generated or produced by an LLM) with feature or attribute values for the relevant input data item.
Narratives may be descriptive and informative: a verification or review process of a sample of the narratives may be performed to assess their quality and coherence.

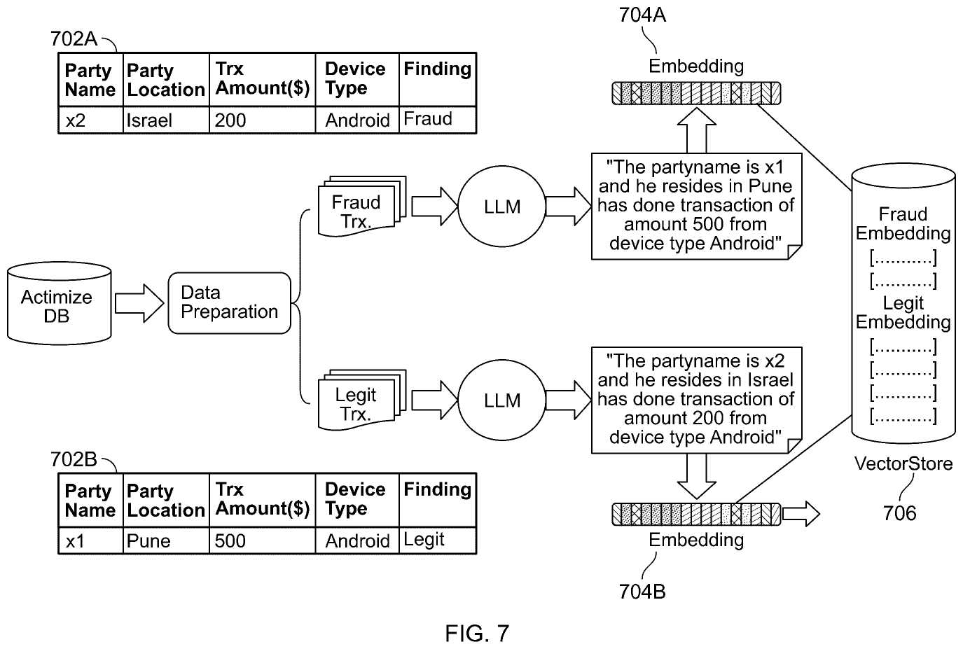

FIG. 7 illustrates an example vector embedding generation process according to some embodiments of the invention.

Some embodiments may include computing, by an internal layer of the machine learning (ML) model, a numerical representation for the generated verbal description. Such an ML model may be a neural network (NN) in which an internal layer produces activations as its output, the activations being an internal representation, which may be considered an embedding. In some example embodiments, the NN may be an LLM or part of an LLM. In some embodiments, models such as, e.g., Titan text embedding models by Amazon (transformer-based, and having vector dimensions ~768-1024), and Cohere Command R and//or Cohere embed v2 (transformer based, vector dimensions: 768), and/or text-embedding-ada-002 by OpenAI (transformer based, outputs vectors of dimension 1536) may be used for generating embeddings—for example as models separate and distinct from the ML model used to generate narratives. A numerical representation or embedding may be the ML's representation of an input at some stage of ML processing; an embedding may represent information such as ML input by reference to similar concepts, in a multi-dimensional space. Embodiments may improve ML or NN technology by using embeddings, as opposed to merely output, of a NN.

For example, embedding generation or creation according to some embodiments of the invention may include, storing generated narratives in separate datasets 702A and 702B, e.g., one dataset for fraudulent and one for legitimate transactions, respectively. Seme embodiments may convert the narratives into numerical representations or vector embeddings 704A-B, e.g., using the LLM and/or additional or alternative embedding models. For example, an embedding generation process may start with tokenizing the input, breaking down words or subwords into numerical tokens. The model or LLM may then pass these tokens through internal layers, that may use attention mechanisms to learn dependencies between tokens and encode semantic and syntactic nuances. As the text moves through these layers, the model or LLM may create, calculate, or generate a contextual vector embedding or numerical representation for the input (such as for example embeddings or vectors 704A-B), e.g., by combining information from each token while accounting for its context within the sentence or paragraph. This final vector, numerical representation, or embedding, may represent the semantic essence of the text, which may be used in subsequent tasks and operations such as, e.g., similarity comparison, clustering, and classification across various applications.

Numerical representations or embeddings 704A-B may be stored in a dedicated database, data store, or storage component 706.

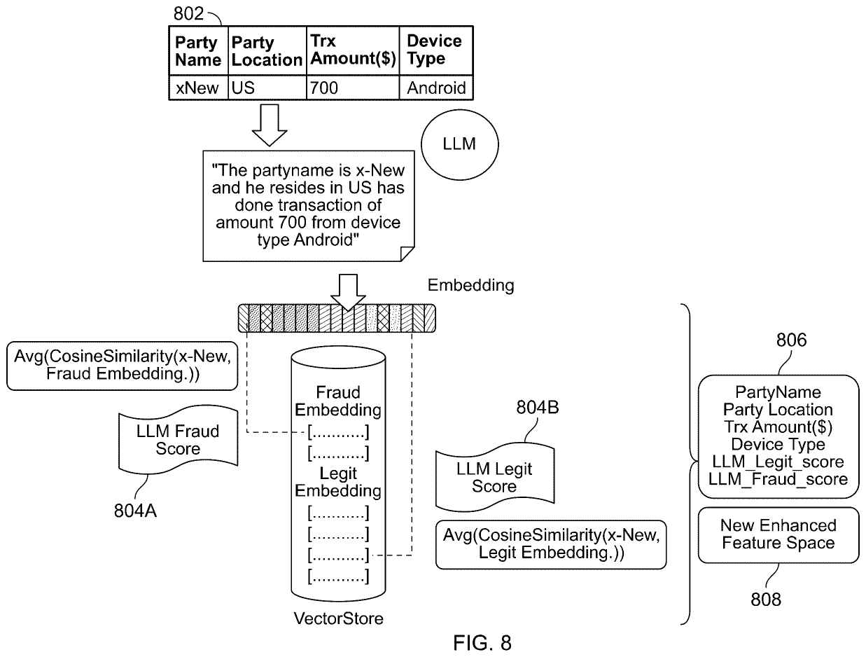

FIG. 8 illustrates an example process for narrative and embedding generation according to some embodiments of the invention.

For a data item describing an incoming or newly received data transfer or computerized transaction 802, some embodiments may generate a verbal description or narrative using an LLM, generate an embedding for the verbal description or narrative, and calculate fraud probabilities or scores using the generated embedding. In some embodiments, scores or probabilities of fraud may include, e.g., a fraud or anomaly score—which may be calculated by comparing the input data item or newly received transaction with a reference embedding(s) or representation(s) of historical data items associated with or labeled as involving fraud. Some embodiments may also include a “legitimate score” as part of scores or probabilities of fraud—which may be calculated by comparing the input data item or newly received transaction with a reference embedding(s) or representation(s) of historical data labeled as not involving fraud. In some embodiments, reference embeddings, vectors, or representations may be, e.g., average embeddings, vectors, or embeddings—which may include average values of a plurality of embeddings describing a plurality of historical data transfers or transactions. For instance, a reference vector or numerical representation used for calculating a fraud score may be calculated as an average of a plurality of embeddings from a database of historical fraudulent transactions, and a reference vector or representation used for calculating a legitimate score may be calculated as an average of a plurality of embeddings from a database of historical non-fraudulent transactions (in some embodiments, separate datasets may be used to store fraudulent and non-fraudulent transactions, as, e.g., described with regard to FIG. 7). In some embodiments, an incoming or base transaction T which may inspected for fraud may be compared with a set of fraudulent transaction vectors, F₁, F₂, F₃ . . . Fₙ, or with vector representations of transactions known or labeled as involving fraud, and/or with a set clean transaction vectors, C₁, C₂, C₃, . . . , Cₘ or with vector representations of transactions known or labeled as being legitimate or as not involving fraud. Similarity scores/distances S(T,Xₙ) may be computed for/between a vector representation or embedding of the incoming transaction T and, e.g., each of the “reference” vectors Fₙ and Cₘ—e.g., S(T,Cₘ), and S(T,Fₙ) where S may be calculated, for example, using the cosine similarity formula for the two input vectors T and Cₘ/Fₙ (used as vectors A and B in the cosine similarity or distance formula). A legitimate or “Legit score”, and/or a fraudulent or “Fraud score” may be calculated as the average of all calculated similarity values for the incoming transaction, e.g., S̅(fraud)=[S̅(T, F₁)+ . . . +S(T, Fₙ)]/n, and S̅(legit)=[S(T, C₁)+ . . . +S(T, Cₘ)]/m. Additional (such as, e.g., max or median or some other aggregation which may be used with or instead of mean/average or a combination of the latter) or alternative fraud or legitimate scores may be used in different embodiments of the invention.

A fraud score 804A (or a “legitimate score” 804B) may be calculated, for example, by determining or computing the similarity between a numerical representation or embedding for the an incoming or newly received data transfer or computerized transaction 802 and the reference embedding for fraudulent transactions (or, in the case of “legitimate score”, for non-fraudulent transactions). In some embodiments, calculated scores or probabilities may be stored and further used as features 806 in a feature space 808 in as part of a multi-feature machine learning based fraud detection process. Additional or alternative fraud scores or probabilities may be calculated in different embodiments.

Some embodiments may include determining a probability of fraud for the input data item based on: the computed numerical representation, and one or more reference numerical representations. In some embodiments, the one or more reference numerical representations describe one or more historical data transfers (e.g., each numerical representation may describe a data transfer), and wherein determining the probability of fraud comprising calculating a cosine similarity score for the computed numerical representation and one or more of the reference numerical representations (for example, an average vector may be calculated for a plurality of historical data transfers known to be associated with fraud, and the average vector may be used as a reference representation to which a numerical representation of an input data item may be compared, e.g., using a cosine similarity score, to produce a fraud score or probability of fraud).

Nonlimiting example calculations or simulations of fraud or anomaly scores—which may be used as embedding based features in elaborate fraud or anomaly detection models according to some embodiments—may include the following operations:
Calculate a similarity score, distance, or value between a given transaction's computed numerical representation or embedding (e.g., an input data item such as for example an incoming transaction) and reference fraud embeddings, vectors, or numerical representations describing data items associated with fraud/labeled as fraudulent (for example, data items describing historical data transfers and gathered during a recent historical period, e.g., 1 month prior to the incoming transaction). In some embodiments, similarity may be calculated using, e.g., a cosine similarity or Euclidean distance formula. The result of this calculation may be a scalar value, or a floating point number between 0.0-1.0 describing, e.g., a probability of fraud, which may be referred to a fraud_comp_score, representing the similarity or dissimilarity of the transaction or input data item to numerical representations or embeddings for historical fraudulent data items or transactions.
A nonlimiting example similarity or distance formula that may be used in some embodiments may be the cosine similarity formula in eq. 2:

$$Cosine Similarity = ( A \cdot B ) / ( ‖ A ‖ ‖ B ‖ ) \qquad ( eq . 2 )$$

Where A·B is the dot product of vectors A and B, and where ∥A∥ and ∥B∥ are the magnitudes (norms) of vectors A and B, respectively. Additional or alternative formulas may be used in different embodiments.
Similarly, some embodiments may calculate the similarity between a given input data item's or transaction's embedding and reference legitimate or non-fraudulent transaction embeddings or numerical representations (describing for example data transfers or transactions performed over a historical period of 1 month prior to a given incoming transaction, and labeled as non-fraudulent). The cosine similarity metric or formula, or a different metric or formula, may be used in similarity calculations. The result may be another scalar value or probability of fraud, which may be referred to as legit_comp_score, representing the similarity or dissimilarity of the current transaction to the historical legitimate or non-fraudulent data items or transactions.
The fraud_comp_score and legit_comp_score values may be used as two new features that may be added to the existing tabular transactional data for a given (e.g., incoming or current) transaction. These features may capture the degree to which the current transaction may resemble historical fraudulent or legitimate transactions based on textual narratives and their embeddings. Higher values of fraud_comp_score may indicate a stronger similarity to historical fraudulent transactions, potentially signaling or showing a higher risk of fraud. Conversely, higher values of legit_comp_score may suggest a stronger resemblance to historical legitimate transactions, indicating a lower risk of fraud.
   Additional or alternative procedures for using narratives and/or embeddings for calculating or generating features to be used as fraud indicators may be used in different embodiments.

Some embodiments may include training a machine learning model (such as, e.g., a second machine learning model, which may be separate and distinct from a first model or LLM used for generating LLM based features and/or narratives) using a cosine similarity score, the cosine similarity score calculated for the computed numerical representation and one or more of the reference numerical representations.

For example, a model training and evaluation process according to some embodiments of the invention may include the following operations:
Splitting data sources (including, e.g., the fraud_comp_score and legit_comp_score features calculated using, e.g., a cosine similarity formula), into training and validation sets.
Selecting and using appropriate machine learning algorithms (such as, e.g., logistic regression which may be used, e.g., for fraud detection tasks with linear decision boundaries, random forest which may be used, e.g., for ensemble-based decision tree modeling with feature importance analysis, gradient boosting for iterative model improvement, for example, by minimizing loss functions, and extreme gradient boosting (XGBoost), e.g., for scalable, regularized boosting with optimized execution through parallelization, and more) for fraud detection.
Training the selected models on the training data (e.g., similarity scores calculated for embeddings or numerical representations of data items and reference representations known to involve or not to involve fraud), which may be labeled using a fraud label (legitimate or fraudulent) which may be used as a target variable for model prediction.
Evaluating the trained models' performance on the validation set using, e.g., detection rates (percentage of fraud transactions detected successfully) and value detection rates (percentage amount of fraud transactions detected successfully).
Obtaining a separate test set or hold-out data that the models have not been exposed to during training.
Evaluating the selected best-performing model on the test set, ideally providing the same performance metrics as provided for the validation set.
Assessing the model's predictability, interpretability and explainability, e.g., particularly with respect to the contributions of the fraud_comp_score and legit_comp_score features.
   Additional or alternative model training operations may be used in different embodiments.

FIG. 9 shows an example feature enhancement procedure according to some embodiments of the invention.

For a new sample output or narrative, some embodiments may generate data including features such as, for example, similarities or distance values, such as, e.g., anomaly or fraud scores including, e.g., a legitimate score and/or fraud score—which may be used to enhance a data transfer or transaction database 902, to create an LLM-feature-enhanced database 904. Data entries in database 902 may accordingly be used, e.g., for calculating fraud probabilities and scores (such as, e.g., fraud score 906A and legitimate score 906B), e.g., using appropriate machine learning models.

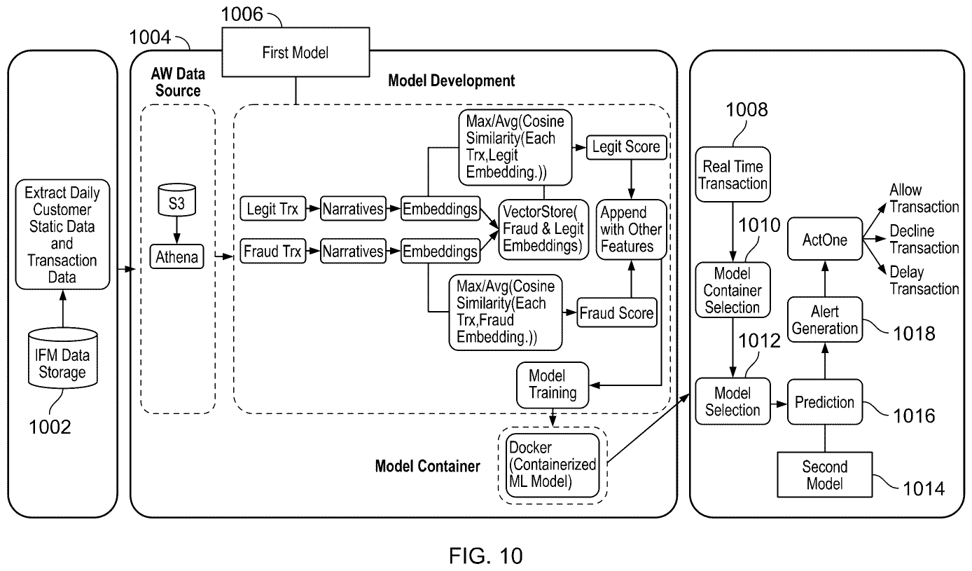

FIG. 10 shows an example system for fraud detection using a large language model (LLM) according to some embodiments of the invention.

Some embodiments may be embedded in fraud detection computer programs and/or software suits such as for example the Integrated Fraud Management (IFM) system as part of the Actimize Watch software suite or system. Different embodiments may be embedded into additional or alternative software and/or fraud detection frameworks.

Some embodiments may extract customer static data and transaction data. This data may be sent to a dedicated server and be stored in a database or in cloud storage components such as, e.g., the S3 and/or Athena components by Amazon Web Services (AWS or AW).

Some embodiments may identify a base activity for which a model needs to be created and/or trained, and data may be filtered to identify relevant features. These features may then used to train a clustering model which may create multiple clusters from the population. For each of the clusters, a machine learning model will be established and/or created and/or trained. Trained models may be used to score transactions in real-time, and to generate alerts and/or perform automated actions such as, e.g., allow, decline or delay an incoming transaction.

IFM (Integrated Fraud Management) may refer to a system encompassing all the tools and processes working together to combat fraud. It may act as a central hub, orchestrating data collection, analysis, and response to suspicious activity.

IFM Data Storage 1002 may include, e.g.:
Customer static data: this may encompass relatively “fixed” or unchanging information about the customer, such as: name, address, contact details (phone number, email), account history (account opening date, account type), product subscriptions (credit cards, debit cards, loans), preferred banking channels (online banking, mobile app, branch visits), and the like.
Transaction data: this may capture a detailed record of each customer interaction, including, for example: transaction type (debit, credit, transfer), amount, timestamp (date and time of transaction), location (physical branch, ATM, online platform), merchant details (for card transactions—name, location), device information (IP address, operating system, device type for online/mobile transactions), and the like.
   These may be used, e.g., as features or attributes according to some embodiments.

LLM based fraud detection 1004:

AW data source: data received from IFM may be store in S3 and is ready for analysis, e.g., using Amazon Athena.

Storage in Amazon S3: the prepared data may be securely stored in Amazon S3, a scalable and cost-effective object storage service offered by Amazon Web Services (AWS). It may act or serve as a central repository for the data, making it readily accessible for further processing.

Analysis with Amazon Athena, an interactive query service, offered by AWS. It may allow analysts to directly query the data stored in S3, for example using standard SQL language. This may eliminate the need to set up and manage a separate database, making data exploration and analysis memory/storage efficient.

EDA(Exploratory Data Analysis) according to some embodiments of the invention may include several modules/operations.

Base activity selection: in this step some embodiments may identify the base activity for which a model may be trained or created. Base activities may represent specific activities a user or customer performed and may determine which detection models may be used or calculated for a transaction. In some embodiments, each transaction may be mapped to one and only one base activity, and a base activity may be calculated or determined for each transaction. For example a base activity may be determined according to the channel and/or the transaction type, as well as additional fields and calculations.

Filter data: some embodiments may perform a pre-processing step, as not all extracted data may be equally relevant for fraud detection. A filtering or preprocessing step may filter out or discard irrelevant or redundant information, focusing on the key features that may best distinguish fraudulent activities. For instance, when creating a model for a retail customer, then using commercial data or other types of data may add noise to the model. Thus, some embodiments may apply filter to only fetch relevant data which may be used for model training. In another example, some embodiments may only use data describing a predetermined time period (such as for example data describing activities by a user performed during the last or most recent six months), and some embodiments may apply a filter to only fetch last 6 months of data.

A generation of LLM based enhanced features (using an LLM or “first model” 1006) according to some embodiments of the invention may include, for example:
Data collection: some embodiments may gather legitimate and fraudulent transaction data, e.g., from the past 3 to 6 months. Datasets may be separated (e.g., into a “legitimate transaction” dataset and a “fraudulent transaction” dataset) and be subject to further processing.
Data preprocessing: since large language models (LLMs, such as, e.g., first model 1006) primarily handle text inputs, some embodiments may convert tabular transaction data into a text format appropriate for LLMs. This may involve, e.g., transforming the data into text prompts or narratives that may describe each transaction.
Embedding creation: fraudulent and legitimate transaction narratives may be converted into numerical representations or embeddings. This may allow the LLM or first model 1006 to efficiently analyze the data. This process may result in two separate embeddings: fraud_embedding (for fraudulent transactions) and legit_embedding (for legitimate or non-fraudulent transactions).
Some embodiments may include determining a probability of fraud for the input data item based on: the computed numerical representation, and one or more reference numerical representations. For example, some embodiments may include score or probability generation operations: an input data item such as, e.g., a new or incoming transaction may have its numerical representation (such as embedding) may be compared to a reference numerical representations or embeddings, such as, e.g., fraud_embedding(s) and legit_embedding(s). This comparison may generate two scores or probabilities of fraud for the new transaction, e.g.: fraud_comp_score and legit_comp_score. These scores may indicate the new transaction's similarity to fraudulent and legitimate transactions, respectively.
Enhanced fraud detection: the scores generated by the LLM or first model 1006 may be integrated with existing traditional models (e.g., with a second model separate and distinct from the first machine learning model or LLM 1006 used to generate LLM based features or fraud probabilities). This combined approach may improve the overall effectiveness of fraud detection.

A nonlimiting example calculation of a probability of fraud according to some embodiments of the invention is provided in Table 1:
An example LLM Prompt: XXX
Data or transaction data:
Party: 13ejdkfi34,
Payee: 1495jgqlz49,
Amount: 100,
Currency: EUR,
Location: Amsterdam,
Device operating system: iOS,
Is New Account: 0,
Based the LLM prompt and data provided as input, an LLM (such as for example the Claude 3.5 Sonnet model) may generate or output a text narrative for a transaction (or for a transaction described by the data included in the prompt or JSON data item), such as, e.g.:
This transaction involved a transfer of 100 EUR from Party 13ejdkfi34 to Payee 1495jgqlz49, occurring in Amsterdam. The transaction was conducted using a device with the iOS operating system, and the party initiating the transaction is using an established account.
The text narrative may then be input into an embedding model (such as for example an Embed model by Cohere), which may generate an embedding, vector, or numerical representation for the narrative and/or transaction (denoted T), such as, e.g.:
T=[0.134, 0.256, −0.784, 0.032, 0.675, −0.123, 0.498, −0.932, 0.276, −0.045, 0.678, 0.298, −0.401, 0.853, 0.006, −0.312, 0.742, −0.156, 0.089, . . . , 0.671, −0.238, 0.003, −0.564, 0.714, −0.801]
Similarity Calculation: the generated embedding T may be compared with each of a plurality of reference vectors or embeddings F1, F2, . . . , Fn (describing, e.g., historical transactions labeled as fraudulent) and/or with reference vectors or embeddings C1, C2, . . . , Cm (describing, e.g., historical transactions labeled as legitimate)—where the reference embeddings may be, e.g., of same dimensions as T. A similarity score for each comparison of T with one of the reference vectors, e.g., S(T, Fn) or S(T, Cm) may be computed as using a cosine similarity formula, For example, for 4 reference vectors F1, F2, C1, C2, the following similarity scores may be calculated or computed: S(T, F1)=0.9, S(T, F2)=0.7, S(T, C1)=0.3, S(T, C2)=0.2. A fraud score or probability of fraud may accordingly be computer as: S̅(fraud)=[0.9+0.7]/2=0.8; A legitimate score (which may, in some embodiments, be used as a probability of fraud or an inverse probability of fraud) may be computer as: S̅(legit)=[0.3+0.2]/2=0.25. These example computed values indicate a high likelihood of fraud for the transaction at hand.

### Table 1.

Additional or alternative operations may be included in calculating a probability of fraud according to different embodiments of the invention.

Model containerization may refer to deploying trained or chosen machine learning model(s) for real-time fraud detection. Traditional machine learning model deployment may involve, e.g., installing dependencies and libraries on a server, which may prove cumbersome and time-consuming. Some embodiments may use the Docker containerization framework, a which may allow packaging the chosen machine learning model, along with all its dependencies (libraries, frameworks) into a lightweight, portable unit which may be referred to as a container.

Some example benefits of using the Docker framework (or a different framework) may include, e.g.:
Isolation: each Docker container may run in isolation from other processes within the system, ensuring the model's environment remains consistent and predictable regardless of the underlying server configuration.
Portability: Docker containers may be self-contained, making it easy to deploy the model across different environments (development, testing, production) without worrying about compatibility issues.
Scalability: Docker containers may be lightweight and can be easily scaled up or down based on processing demands. This may allow for efficient resource utilization, especially when handling high volumes of real-time transactions or transaction data.

Once machine learning models are containerized, they may be deployed in a production environment or environments. This may involve using container orchestration tools such as for example the Kubernetes platform to manage the lifecycle of the containers, ensuring they run smoothly and may be scaled appropriately to handle real-time data traffic.

Real time transaction 1008 may refer to or may represents incoming transaction data that the system may analyze to identify potential fraud. This data may include, e.g., details about a customer's transaction, such as the amount, timestamp, location (physical branch, ATM, online platform), merchant details (for card transactions), device information, and the like.

Model container selection 1010 may refer to the process of choosing the appropriate machine learning model to assess or evaluate the incoming transaction, e.g., by calculating a fraud score or probability. The IFM system may store multiple pre-trained models, and may select the most suitable one based on factors such as, e.g., the type of transaction or customer segment. Model selection 1012 may include selecting a model that may be used in some embodiments to predict a final fraud score or probability of fraud using LLM based features and/or additional features. In some embodiments, the selected model 1014 may be used as a “second machine learning model”, or as a model separate and distinct from a first machine learning model or LLM used for generating LLM based features. The second machine learning model may receive and/or may be trained using data including LLM based features, to predict or output a final probability of fraud for an incoming transaction or input data item.

Real time creation of LLM based features: each new or incoming real-time transaction may be compared to historical vector representations of fraudulent and legitimate transactions learned by the LLM or first model 1006 (e.g., by using a cosine distance/similarity formula to calculate the similarity between an embedding describing a text representation of an incoming transaction with a reference vector or embedding calculated as an average of multiple embeddings, each representing a fraudulent/legitimate transaction) generating a fraud score and a legitimacy score (e.g., as the output of similarity or distance calculations). These scores may indicate the transaction's similarity to fraudulent and legitimate activities, respectively.

In some embodiments, the determining of a probability of fraud is performed using a second machine learning model.

Prediction 1016: incoming real-time transactions along with fraud score and legitimate score may be fed into an appropriate machine learning model (e.g., a second machine learning model 1014) such as, e.g., the extreme gradient boosting (XGB) classifier—which may be a second model, e.g., separate and distinct from the machine learning model or LLM used for generating fraud scores and legitimate scores and/or other LLM based features—for final prediction of a fraud probability or score, which may be a floating-point number between 0 (low probability of fraud, likely legitimate transaction) and 1 (likely fraudulent transaction). The system may use this fraud probability or score to determine whether the transaction is legitimate or suspicious and/or to generate alerts 1018 and/or perform appropriate automated actions. In some example embodiments, LLM based features may be used together with other features in, e.g., a multivariate linear regression equation:

$$\hat{y} = {w}_{1} {x}_{1} + {w}_{2} {x}_{2} + … + {w}_{n} {x}_{n} + b \qquad ( eq . 3 )$$

Where ŷ is the predicted output or final score, x₁, x₂, . . . , xₙ are the input features or variables for a given input (including, inter alia, a fraud score and a legitimate score as two of the features), w₁, w₂, . . . , wₙ are weights (coefficients) assigned to each feature, and b is a constant or bias term. Additional or alternative equations and models may be used for predicting final fraud scores based on fraud scores or probabilities such as a fraud score and a legitimate score—which may be generated by an LLM and be used as LLM based enhanced features.

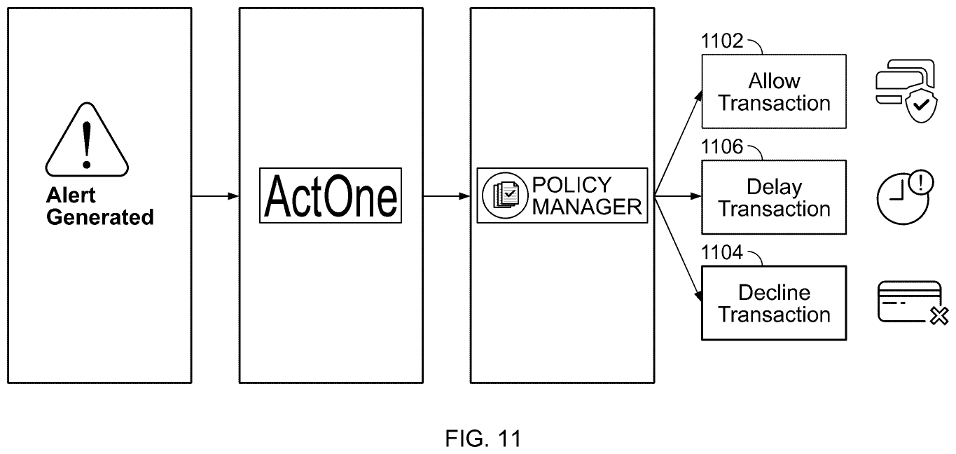

FIG. 11 shows an example process for alert generation and for performing automated actions according to some embodiments of the invention.

Some embodiments may include performing one or more of: performing a data transfer, blocking a data transfer, and delaying a data transfer based on the determined probability of fraud.

Alert generation: in some embodiments, if the transaction score, anomaly score, or fraud probability is greater then a threshold (e.g., a threshold T=0.7) the system may generate an alert. Depending on the severity of the score and pre-configured rules, the system might automatically take actions such as, e.g.:
Allow transaction 1102: this may represent or correspond to the ideal scenario where the score is below the threshold, indicating a low fraud risk. The transaction or data transfer may be processed and allowed to proceed and be performed without restrictions.
Decline transaction 1104: this may occur when the score is significantly above the threshold (e.g., at least 0.2 above threshold T: for example a calculated score or probability of 0.9>T=0.7), indicative of a high likelihood of fraud. The system may automatically decline or block the transaction, e.g., to prevent potential financial losses.
Delay transaction 1106: this may happen for transactions with scores exceeding threshold T(but perhaps not as high as the automatic decline threshold: e.g., if T is exceeded by an amount X>0.2). The transaction may be flagged as suspicious, but the system may delay and hold it for a predetermined time period (e.g., 2 days), e.g., to allow a fraud analyst to review the details before making a final decision whether to allow or decline the transaction.

In some embodiments, all transactions for which calculated scores or probabilities of fraud exceed threshold T may result in an alert being generated. The system may assign different severity levels to the alerts based on the perceived risk and different automated actions may be taken.

Additional or alternative automated actions, thresholds and alerts may be used in different embodiments.

All alerts and scores may be sent to a fraud detection program or platform such as, e.g., NICE Actimize's ActOne (used herein as a nonlimiting example). Some embodiments, for example when combined or used with the nonlimiting example of ActOne platform by NICE Actimize may be used to transform financial crime investigations by introducing intelligent automation and visual storytelling for speed and accuracy. Intelligent automation may save time by enabling a virtual workforce of robots to collaborate with human investigators, while visual storytelling may uncover more risks by showing relationships between entities, alerts and cases in a visual manner.

Managing fraud risk and investigations is becoming more complex and costly (possibly more than ever before). Different organizations require a new approach to alert and case management that may enable their analysts and investigators to reduce fraud investigation time and improve automated decision making and transaction management. Some embodiments may improve machine learning technology and fraud detection technology by providing a flexible, yet robust approach for fraud detection: some embodiments may be able to detect fraud based on unstructured inputs (which may be handled by LLMs) and perform automated actions and/or generate alerts based on scores generated for these inputs, thereby improving fraud detection accuracy and applicability to different inputs without imposing undesirable computational cost requirements.

Some embodiments may allow users to create rules using an intuitive user interface, and may identify hidden relationships and explore networks to identify risks, ensuring a comprehensive understanding of fraud patterns. Some embodiments may include a policy manager module or component that may takes client configurability a step further by, e.g., allowing a user or client to define thresholds that determine how aggressively the system flags transactions for review. This may allow to strike a balance between risk mitigation and user experience.

After an alert is generated, some embodiments may allow to configure automated steps which will utilize alert score and other simple relevant features, such as, e.g., an amount of the transaction, a location of the transaction or parties involved, and the like. Based on such factors and/or additional logic, automated actions may be performed.

Some embodiments may evaluate transactions using a feature-based risk assessment and based on a set of pre-defined features or attributes, such as, for example:
Transaction amount: smaller transactions such as, e.g., a $10 automate teller machine (ATM) cash withdrawal may be considered less risky by default.
Transaction location: transactions originating from a familiar ATM location used by the customer frequently may be determined less suspicious than, e.g., a transaction associated or performed from a high-risk geographic area.
Customer behavior: the system may consider the customer's historical transaction patterns. A small withdrawal from an ATM may be normal or common for a customer who typically makes small, frequent withdrawals, but highly unusual for, e.g., a user or customer who usually makes large purchases.
Device characteristics: some embodiments may handle transactions from unrecognized devices or those known to be associated with fraudulent activity by raising an appropriate alert or “red flag”.
   Additional or alternative features and/or logic may be used in different embodiments.

Threshold configuration: some embodiments may allow a user or system administrator to define thresholds for each feature or a combination of features, based on which automated actions may be performed.

Allow transaction: based on configured thresholds and relevant feature values some embodiments may determine if a transaction is to be allowed. For example, a threshold T2 may be set for a transaction amount, such as, e.g., T2=$100. Transactions below this amount may be determined to involve lower risk, even if an alert score probability of fraud generated by the system is slightly above a pre-defined threshold for fraud likelihood. In this scenario, the system may allow the transaction to proceed despite the calculated probability of fraud and/or alert. This may allows to prioritize fraud detection resources by focusing on higher-risk transactions that exceed the configured thresholds.

Delay transaction: in a nonlimiting example of an ATM transaction at a high transaction amount, e.g., $1000, the transaction may be riskier and need to be investigated. A high-value transaction, such as, e.g., a $1000 ATM withdrawal, may be more important to the customer compared to a small withdrawal. A fraudulent high-value withdrawal may result in significant financial loss for the customer. Large cash withdrawals may be a red flag for money laundering activities. By monitoring high-value ATM transactions, embodiments may help mitigate the risk of being used for illicit purposes. Hence in such case, some embodiments may delay the transaction for a predetermined time period (e.g., 3 days).

Decline transaction: in an example scenario where fraud scores calculated for a transaction may be very high (indicating a very high likelihood of fraud) some embodiments may automatically decline or reject the transaction (e.g., in real time, and immediately after the transaction is received, or after a transaction request is stored in the system). For example, a transaction amount for a given transaction may be significantly high compared to the customer's typical spending patterns: such as, e.g., a customer with an average monthly spending of $100 attempting to withdraw $10000 from an ATM. The transaction may be accompanied by other red flags or suspicious features, such as, e.g., originating from a known blacklisted location or involving a recently compromised account. A high threshold (e.g., of T=0.9 for a fraud probability or score calculated, e.g., using a cosine similarity to a reference fraud embedding) may signify transactions that are considered to be very high risk, exceeding usual tolerance levels. When an incoming transaction surpasses this high threshold, some embodiments may automatically decline in real time and without delay (e.g., immediately after a transaction record or request is received at the system). This immediate action may minimize the potential for financial loss in case of fraudulent activity.

Additional or alternative automated actions and/or thresholds for feature values may be used in different embodiments.

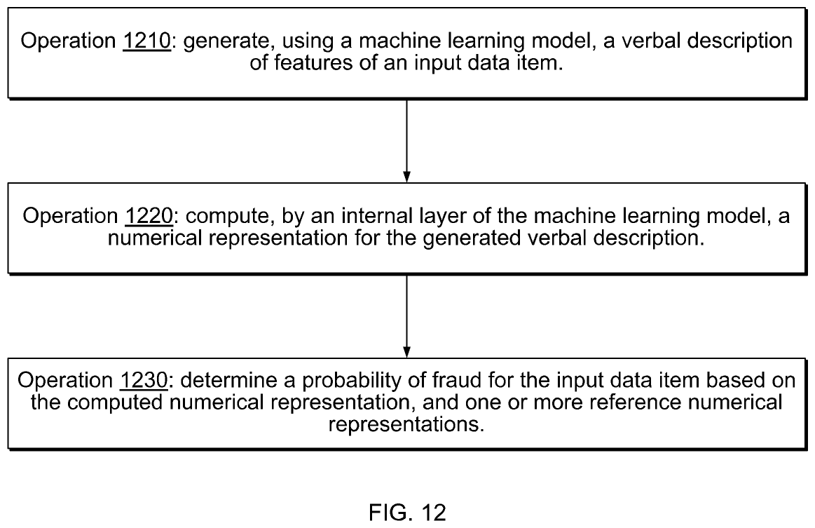

FIG. 12 shows an example process of computerized fraud detection according to some embodiments of the invention. In operation 1210, some embodiments may generate, using a machine learning model or LLM, a verbal description of one or more features of an input data item (for example, tabular data or database entries describing a data transfer may be provided to the LLM, and a human readable text narrative describing attributes/features/database values for the data transfer may be generated or output by the LLM). Some embodiments may compute, by an internal layer of the machine learning model, a numerical representation for the generated verbal description (for example, the LLM, or a different embedding model, may calculate a vector embedding or numerical representation for text narrative generated of the data transfer; operation 1220). Some embodiments may determine a probability of fraud for the input data item based on: the computed numerical representation, and one or more reference numerical representations (for example, the embedding or representation generated using the narrative and describing the data transfer may be compared to reference embeddings associated with fraudulent data transfers, e.g., using a cosine similarity or distance formula—and if a similarity value higher than a threshold is received, some embodiments may determine or label the data transfer as fraudulent. Otherwise, some embodiments may determine or label the data transfer as non-fraudulent or as legitimate; operation 1230). For an incoming or newly requested data transfer, some embodiments may perform automated actions such as, e.g., block, delay, or allow the transfer based on the probability of fraud calculated for it. Additional or alternative operations may be included in different embodiments.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for computerized fraud detection using a machine learning model, the method comprising, using one or more computer processors:
generating, using a machine learning model, a verbal description of one or more features of an input data item;
computing, by an internal layer of the machine learning model, a numerical representation for the generated verbal description; and
determining a probability of fraud for the input data item based on: the computed numerical representation, and one or more reference numerical representations.

2. The method of claim 1, wherein the one or more reference numerical representations describe one or more historical data transfers, and wherein the determining of the probability of fraud comprises calculating a cosine similarity score for the computed numerical representation and one or more of the reference numerical representations.

3. The method of claim 1, wherein the determining of the probability of fraud is performed using a second machine learning model, the second machine learning model trained using one or more training data items, wherein the training data items are received within a predetermined time period, and wherein each of training data items is sampled based on a Bernoulli trial.

4. The method of claim 3, wherein one or more of the training data items are labeled based on one or more of: a time difference between a given training data item and a fraudulent data item, and a feature common to the given data item and to the fraudulent data item.

5. The method of claim 3, comprising training the second machine learning model using a cosine similarity score, the cosine similarity score calculated for the computed numerical representation and one or more of the reference numerical representations.

6. The method of claim 1, wherein the input data item comprises tabular data, the tabular data converted into a large language model (LLM) prompt format.

7. The method of claim 1, comprising one or more of: performing a data transfer, blocking a data transfer, and delaying a data transfer based on the determined probability of fraud.

8. A computerized system for fraud detection using a machine learning model, the system comprising:
a memory; and
one or more processors configured to:
generate, using a machine learning model, a verbal description of one or more features of an input data item;
compute, by an internal layer of the machine learning model, a numerical representation for the generated verbal description; and
determine a probability of fraud for the input data item based on: the computed numerical representation, and one or more reference numerical representations.

9. The system of claim 8, wherein the one or more reference numerical representations describe one or more historical data transfers, and wherein the determining of the probability of fraud comprises calculating a cosine similarity score for the computed numerical representation and one or more of the reference numerical representations.

10. The system of claim 8, wherein the determining of the probability of fraud is performed using a second machine learning model, the second machine learning model trained using one or more training data items, wherein the training data items are received within a predetermined time period, and wherein each of training data items is sampled based on a Bernoulli trial.

11. The system of claim 10, wherein one or more of the training data items are labeled based on one or more of: a time difference between a given training data item and a fraudulent data item, and a feature common to the given data item and to the fraudulent data item.

12. The system of claim 10, wherein one or more of the processors is to train the second machine learning model using a cosine similarity score, the cosine similarity score calculated for the computed numerical representation and one or more of the reference numerical representations.

13. The system of claim 8, wherein the input data item comprises tabular data, the tabular data converted into a large language model (LLM) prompt format.

14. The system of claim 8, wherein one or more of the processors are to perform one or more of: performing a data transfer, blocking a data transfer, and delaying a data transfer based on the determined probability of fraud.

15. A method for computerized anomaly detection, the method comprising, using one or more computer processors:
generating, using a large language model (LLM), a text narrative, the text narrative describing one or more attributes of an input data item;
calculating a vector embedding for the generated text narrative; and
calculating an anomaly score for the input data item based on: the calculated vector embedding, and one or more reference vectors.

16. The method of claim 15, wherein the one or more reference vectors describe one or more historical data transfers, and wherein the calculating of the anomaly score comprises calculating a cosine distance between the calculated vector embedding and one or more of the reference vectors.

17. The method of claim 15, wherein the calculating of the anomaly score is performed using a second machine learning model, the second machine learning model trained using one or more training data items, wherein the training data items are received within a predetermined time period, and wherein each of training data items is sampled based on a Bernoulli trial.

18. The method of claim 17, wherein one or more of the training data items are labeled based on one or more of: a time difference between a given training data item and an anomalous data item, and an attribute common to the given data item and to the anomalous data item.

19. The method of claim 17, comprising training the second machine learning model using a cosine distance value, the cosine distance value computed for the calculated vector embedding and one or more of the reference vectors.

20. The method of claim 15, comprising one or more of: performing a data transfer, blocking a data transfer, and delaying a data transfer based on the calculated anomaly score.
